(19) United States
(12) Patent Application Publication
(10) Pub. No.: US 2025/0156848 A1
(43) Pub. Date: May 15, 2025

(54) INFORMATION PROCESSING METHOD

(71) Applicant: TOYOTA JIDOSHA KABUSHIKI KAISHA, Toyota-shi (JP)

(72) Inventors: Naoki ISHIHARA, Nisshin-shi (JP); Naritomo MIURA, Miyoshi-shi (JP); Shinya MIYASAKA, Okazaki-shi (JP)

(73) Assignee: TOYOTA JIDOSHA KABUSHIKI KAISHA, Toyota-shi (JP)

(21) Appl. No.: 18/768,538

(22) Filed: Jul. 10, 2024

(30) Foreign Application Priority Data
Nov. 14, 2023 (JP) 2023-193725

(51) Int. Cl. G06Q 20/36

(52) U.S. Cl. CPC G06Q 20/36; G06Q 2220/00

(57) ABSTRACT

The information processing method includes a receiving step of receiving a use request of one learned model registered in the distributed ledger, a issuing step of issuing a token to a wallet of a provider of one learned model when the use request is received, and a granting step of granting a non-transferable token to the wallet based on the cumulative amount of the token issued to the wallet.

### CROSS-REFERENCE TO RELATED APPLICATION

This application claims priority to Japanese Patent Application No. 2023-193725 filed on Nov. 14, 2023, incorporated herein by reference in its entirety.

### BACKGROUND

### 1. Technical Field

The present disclosure relates to a technical field of an information processing method using a distributed ledger technology.

### 2. Description of Related Art

As such a method, for example, a method of managing product development data using the distributed ledger technology has been proposed (see Japanese Unexamined Patent Application Publication No. 2023-146501 (JP 2023-146501 A)).

### SUMMARY

For example, when data is registered in a distributed ledger, the registered data can be shared among a plurality of persons while preventing falsification of the registered data. For example, when trained models obtained as a result of machine learning are registered in a distributed ledger, a person different from a person who has provided one trained model can also use the one trained model. An incentive is often not given to the person who has provided the one trained model.

The present disclosure has been made in view of the above circumstances, and an object of the present disclosure is to provide an information processing method capable of giving an incentive to a provider of a trained model.

An information processing method according to an aspect of the present disclosure includes:
a receiving step for receiving a use request for one trained model registered in a distributed ledger;
an issuing step for issuing a token to a wallet of a provider of the one trained model when the use request is received; and
a granting step for granting a non-transferable token to the wallet based on a cumulative amount of tokens issued to the wallet.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram illustrating a concept of an information processing system according to an embodiment;

FIG. 2 is a diagram illustrating an example of a configuration of an information processing system according to the embodiment;

FIG. 3 is a flow chart illustrating an exemplary operation of the information processing apparatus according to the embodiment; and

FIG. 4 is a flowchart illustrating another example of the operation of the information processing system according to the embodiment.

### DETAILED DESCRIPTION OF EMBODIMENTS

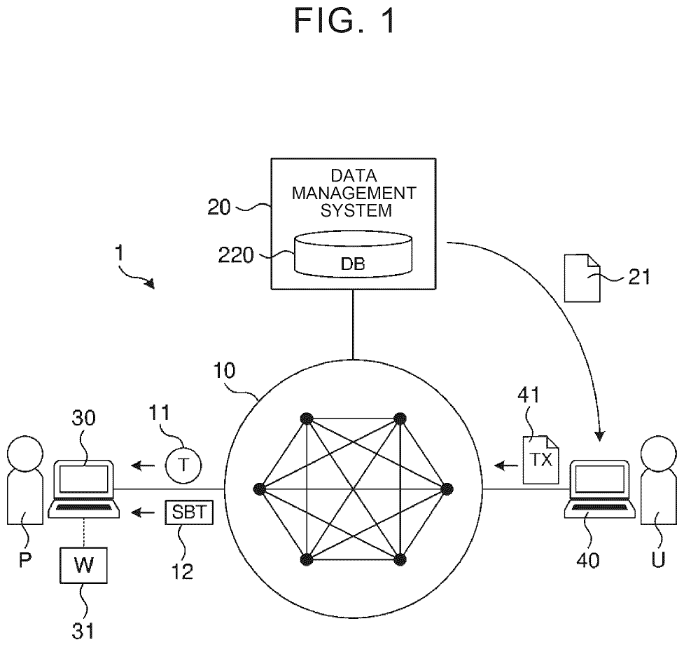

An embodiment of an information processing method will be described with reference to FIGS. 1 to 4. An information processing system to which the information processing method according to the embodiment is applied will be described.

### Concept of Information Processing System 1

First, the concept of the information processing system 1 will be described with reference to FIG. 1. In FIG. 1, an information processing system 1 includes a distributed network 10 and a data management system 20. The distributed network 10 is a network for realizing a distributed ledger. In the present embodiment, a blockchain is exemplified as an example of a distributed ledger.

The data management system 20 includes a database (DB) 220. For example, a learned model generated by machine learning may be registered in the database 220. For example, the learned model may be a learned model applicable to an automated driving system of a vehicle. For example, the learned model may be a learned model applicable to a navigation device. The learned model is not limited to a learned model applicable to at least one of the automated driving system and the navigation device.

Note that, in addition to or in place of the learned model, at least one of the learning data used for learning the learned model and the source code used for learning the learned model may be registered in the database 220. Note that the data management system 20 may include at least one of a database in which the learned data is registered and a database in which the source code is registered, in addition to or in place of the database 220 in which the learned model is registered.

The learned model registered in the database 220 may be provided by the provider P. The provider P may access the information processing system 1 via the terminal device 30. For example, the provider P may generate a transaction requesting registration of one learned model via the terminal device 30. For example, the generated transaction may include identification information for identifying the provider P and model information indicating one learned model. An example of the identification information for identifying the provider P is a user account associated with the provider P. An example of the model information is a file name of one learned model.

As a result of processing the generated transaction in the distributed network 10 (for example, as a result of registering the transaction in the distributed ledger), information for registering one learned model in the database 220 may be provided to the provider P. Based on the information, the provider P may register one learned model in the database 220 via the terminal device 30. In this case, for example, one learned model may be registered in the database 220 in association with identification information related to the provider P. An example of information for registering one piece of learned data in the database 220 is link information to the database 220.

When one learned model is registered in the database 220, a different person (for example, the user U) from the provider P can use one learned model. The user U may access the information processing system 1 via the terminal device 40. For example, if the user U wishes to utilize one learned model, the user U may generate a Transaction 41 that requires the utilization of one learned model via the terminal device 40. For example, the transaction 41 may include identification information for identifying the user U and model information indicating one learned model. An example of the identification information for identifying the user U is a user account associated with the user U.

As a result of the transaction 41 being processed by the distributed network 10 (for example, as a result of the transaction 41 being registered in the distributed ledger), information for obtaining one learned model from the database 220 may be provided to the user U. Based on the information, the user U may acquire one learned model (see reference numeral “21” in FIG. 1) from the database 220 via the terminal device 40. An example of information for acquiring one learned model from the database 220 is link information to the database 220.

The distributed network 10 that processed the transaction 41 may issue a token 11 to the provider P that provided one learned model. The token 11 may be given to the wallet 31 of the provider P. The wallet 31 may be managed by a distributed ledger realized by the distributed network 10, or may be managed by a distributed ledger realized by a distributed network different from the distributed network 10.

The distributed network 10 may further assign the non-transferable token 12 to the wallet 31 of the provider P based on the cumulative amount of the token 11 issued to the provider P. For example, when the cumulative amount of the token 11 issued to the provider P is equal to or greater than “1”, the distributed network 10 may assign a token indicating the first rank to the wallet 31 as the non-transferable token 12. When the cumulative amount of the token 11 issued to the provider P is equal to or greater than “10”, the distributed network 10 may assign, as the non-transferable token 12, a token indicating a second rank that is a rank higher than the first rank to the wallet 31. When the cumulative amount of the token 11 issued to the provider P is equal to or greater than “100”, the distributed network 10 may assign, as the non-transferable token 12, a token indicating a third rank that is a rank higher than the second rank to the wallet 31. An exception to the non-transferable token 12 is the Seoul Bound Token (SBT).

### One Specific Example of Information Processing System 1

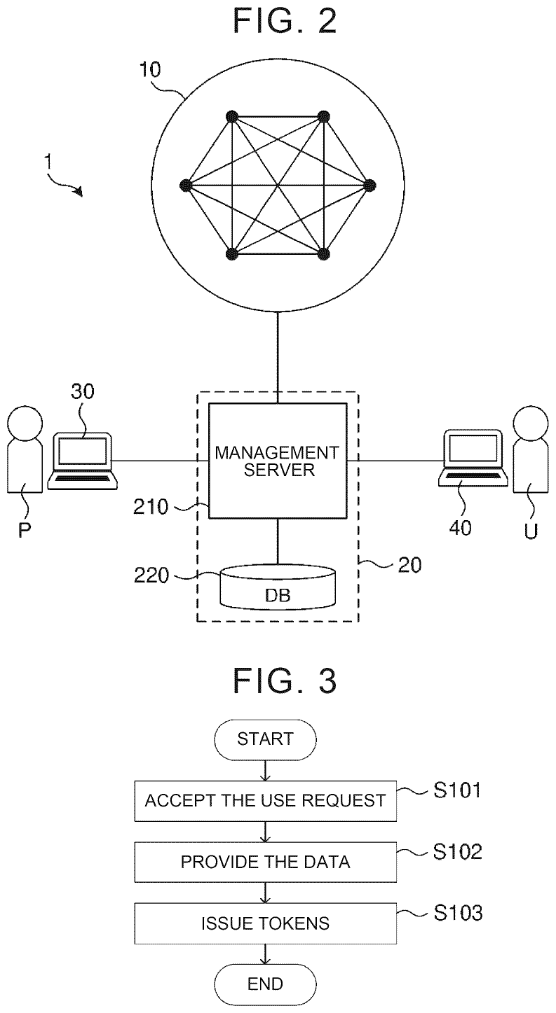

Next, a specific example of the configuration of the information processing system 1 will be described with reference to FIG. 2. In FIG. 2, the information processing system 1 includes a distributed network 10 and a data management system 20. The data management system 20 includes a management server 210 and a database 220. Each of the terminal devices 30 and 40 may be connected to the management server 210 via a wide area network such as the Internet.

The management server 210 may provide the provider P and the user U with an application for browsing the distributed ledger realized by the distributed network 10 and an application for accessing the database 220. Therefore, the management server 210 may be referred to as an application server.

For example, when the provider P registers one learned model in the database 220, the provider P may transmit registration request information for requesting registration of one learned model to the management server 210 using an application provided by the management server 210. Upon receiving the registration request information, the management server 210 may generate a transaction requesting registration of one learned model. After the transaction is processed by the distributed network 10, the management server 210 may transmit display information for displaying information for registering one learned model in the database 220 on a screen related to the application to the terminal device 30. The terminal device 30 that has received the display information may display information for registering one learned model in the database 220. Thereafter, the provider P may register one learned model in the database 220 using the application provided by the management server 210.

For example, if the user U utilizes one learned model, the user U may send utilization request information to the management server 210 to request the utilization of one learned model using the application provided by the management server 210. Upon receiving the use request information, the management server 210 may generate a transaction requesting use of one learned model (for example, corresponding to the transaction 41 illustrated in FIG. 1). After the transaction is processed by the distributed network 10, the management server 210 may transmit display information for displaying information for acquiring one learned model from the database 220 to the terminal device 40 on a screen related to the application. The terminal device 40 that has received the display information may display information for acquiring one learned model from the database 220. Thereafter, the user U may acquire one learned model from the database 220 using an application provided by the management server 210.

The distributed network 10 that has processed the transaction requesting the use of one learned model may issue a token 11 to the provider P. In this case, the management server 210 may give the token 11 to the wallet 31 of the provider P. The distributed network 10 may further issue the non-transferable token 12 to the provider P based on the cumulative amount of the token 11 issued to the provider P. In this case, the management server 210 may assign the non-transferable token 12 to the wallet 31 of the provider P.

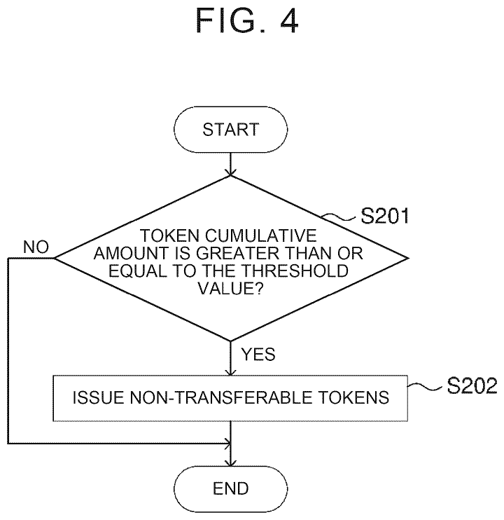

Next, the operation of the information processing system 1 will be described with reference to the flowcharts of FIG. 3 and FIG. 4. In FIG. 3, the information processing system 1 (for example, the management server 210) receives a use request of one learned model from the user U (S101). The information processing system 1 (for example, the management server 210) provides the user U with a learned model (i.e., data) based on the received usage request (S102). The information processing system 1 (e.g., the distributed network 10) issues the token 11 to the provider P that provided one learned model in parallel with S102 process (S103).

In FIG. 4, the information processing system 1 (for example, the distributed network 10) determines whether the cumulative quantity of the tokens 11 issued to the provider P is equal to or greater than a threshold (S201). When it is determined that the cumulative amount of the token 11 is equal to or larger than the threshold value (S201: Yes), the information processing system 1 (for example, the distributed network 10) issues the non-transferable token 12 to the provider P (S202). On the other hand, when it is determined that the cumulative amount of the token 11 is not equal to or larger than the threshold (S201: No), the operation illustrated in FIG. 4 is ended. Note that the operation illustrated in FIG. 4 may be performed when a new token 11 is issued to the provider P.

### Technical Effect

In the information processing system 1, when one learned model provided by the provider P is used by the user U, the token 11 is issued to the provider P. For this reason, as one learned model is used by a large number of users, the cumulative amount of tokens 11 issued to the provider P increases. For example, as the cumulative amount of the token 11 issued to the provider P increases, it can be said that one learned model provided by the provider P contributes to another (for example, the user U). Therefore, it can be said that the cumulative amount of the token 11 issued to the provider P indicates at least one of the evaluation for the provider P and the achievement of the provider P.

Further, in the information processing system 1, the non-transferable token 12 is issued to the provider P based on the cumulative amount of the token 11 issued to the provider P. When the cumulative amount of the tokens 11 is relatively large, the information processing system 1 may issue the non-transferable token 12 of a higher rank to the provider P than when the cumulative amount of the tokens 11 is relatively small. Therefore, it can be said that the non-transferable token 12 issued to the provider P indicates at least one of the evaluation of the provider P and the achievement of the provider P. Since the non-transferable token 12 is non-transferable, the reliability of at least one of the evaluation and the achievement of the provider P indicated by the non-transferable token 12 can be ensured.

Note that the non-transferable token 12 may be opened to the public. In this case, the user U can determine whether to use one learned model provided by the provider P with reference to the non-transferable token 12 of the provider P. Note that the token 11 may be a transferable token. For example, the token 11 may be a token that can be exchanged with at least one of a commodity and a service.

As described above, in the information processing system 1, when one learned model is used by the user U, the token 11 is issued to the provider P that provided the one learned model. At the same time, the non-transferable token 12 is issued based on the cumulative amount of the token 11. Therefore, issuance of the token 11 and the non-transferable token 12 may motivate the provider P to actively engage in providing the learned model. Therefore, according to the information processing system 1, that is, according to the information processing method applied to the information processing system 1, it is possible to give an incentive to the provider of the learned model.

### MODIFIED EXAMPLES

The information processing system 1 (for example, the distributed network 10) may issue one token 11 every time one learned model is used once. That is, the information processing system 1 may issue a predetermined amount of tokens 11 for one use of one learned model. The information processing system 1 (for example, the distributed network 10) may additionally issue the token 11 to the provider P that provided one learned model based on the request of the user U. For example, a user U utilizing one learned model may evaluate one learned model. Then, the user U may request the information processing system 1 to additionally issue the token 11 to the provider P in accordance with the evaluation of one learned model. In this case, the user U may be paid money according to the amount of the token 11 additionally issued to the provider P. That is, the token 11 additionally issued to the provider P may be charged. Note that the information processing system 1 may constitute at least a part of an open data mathematical place.

Various aspects of the disclosure derived from the embodiments and modifications described above are described below.

An information processing method according to an aspect of the disclosure includes:
a receiving step of receiving a request to use one learned model registered in the distributed ledger;
an issuing step of issuing a token to a wallet of a provider of the above-mentioned one learned model when the aforementioned use request is received; and
a granting step of granting a non-transferable token to the wallet based on a cumulative amount of tokens issued to the wallet.

In the information processing method, the non-transferable token may indicate at least one of evaluation and achievement of the provider.

An information processing system according to an aspect of the disclosure includes a distributed network for realizing a distributed ledger, and a management device for managing one learned model registered in the distributed ledger. The distributed network receives a use request of the one learned model, and when the use request is received, issues a token to a wallet of a provider of the one learned model. A non-transferable token is assigned to the wallet based on the cumulative amount of tokens issued to the wallet. The “data management system 20” in the above-described embodiment corresponds to an example of a “management device”.

In the information processing system, the non-transferable token may indicate at least one of evaluation and achievement of the provider.

The present disclosure is not limited to the above-described embodiments, and can be modified as appropriate within the scope and spirit of the disclosure that can be read from the claims and the entire specification, and an information processing method accompanied by such a modification is also included in the technical scope of the present disclosure.

What is claimed is:

1. An information processing method comprising:
a receiving step for receiving a use request for one trained model registered in a distributed ledger;
an issuing step for issuing a token to a wallet of a provider of the one trained model when the use request is received; and
a granting step for granting a non-transferable token to the wallet based on a cumulative amount of tokens issued to the wallet.

2. The information processing method according to claim 1, wherein the non-transferable token indicates at least one of evaluation and achievement of the provider.
